(19) United States
(12) Patent Application Publication
(10) Pub. No.: US 2019/0278541 A1
(43) Pub. Date: Sep. 12, 2019

(54) IMAGE FORMING APPARATUS

(71) Applicant: SHARP KABUSHIKI KAISHA, Sakai City (JP)

(72) Inventor: DAIKI YASHIMA, Sakai City (JP)

(21) Appl. No.: 16/291,794

(22) Filed: Mar. 4, 2019

(30) Foreign Application Priority Data
Mar. 9, 2018 (JP) 2018-043007

(51) Int. Cl. G06F 3/12; G08B 13/22; H04N 1/00; H04N 1/44

(52) U.S. Cl. CPC G06F 3/1238; G08B 13/22; H04N 1/00323; G06F 3/1222; H04N 2201/0094; H04N 1/4433; H04N 1/00925; G06F 3/1284; H04N 1/4413

(57) ABSTRACT

An image forming apparatus includes an intruder detecting unit that detects an intruder, an intruder detection mode execution unit that executes an intruder detection mode by causing the intruder detecting unit to detect the intruder, a user authentication unit that performs user authentication, and a job reception unit that receives an instruction to print print data, and a printing unit that prints the print data. If the job reception unit receives the instruction to print the print data while the intruder detection mode execution unit executes the intruder detection mode, the user authentication unit performs the user authentication, and the printing unit prints the print data after the user authentication unit has performed the user authentication of an authorized user.

### BACKGROUND

### 1. Field

The present disclosure relates to an image forming apparatus.

### 2. Description of the Related Art

Many of multifunction apparatuses have a power saving mode available to save power in addition to a standard operation mode. A typical multifunction apparatus having the power saving mode includes a human-body detecting device, such as a human-body detecting sensor, and an imaging device, such as a camera, and is thus automatically switched between the standard operation mode and the power saving mode. Upon detecting a human, the multifunction apparatus reverts from the power saving mode to the standard operation mode in a typical related art operation.

In a multifunction apparatus of the related art, an intruder detection function is implemented by using as a security system the human-body detecting device and the imaging device in the multifunction apparatus. The intruder detection function may include notifying a user of the presence of an intruder or beeping a warning sound if the human-body detecting device detects an intruder in an intruder detection mode.

Japanese Unexamined Patent Application Publication No. 2007-79692 discloses a multifunction apparatus having such an intruder detection function. The multifunction apparatus includes a sensor detecting a human, and is connected to a control apparatus via a network. The multifunction apparatus further includes a unit that notifies the control apparatus of detection results if the sensor has detected a human body. Japanese Unexamined Patent Application Publication No. 2015-133028 discloses an image forming apparatus. The image forming apparatus includes an imaging unit that takes a picture of a predetermined monitoring area, a human detection unit that detects a human with the image forming apparatus operating at power lower than power that the image forming apparatus consumes in the normal operation thereof, and a switching unit that switchably selects of one of a first waiting mode and a second waiting mode. In the first waiting mode, power fed to the imaging unit is sufficient for the imaging unit to take the picture of the predetermined monitoring area when the human detection unit detects a human, and in the second waiting mode, power fed to the imaging unit is sufficient for the image unit to take the picture of the predetermined monitoring area regardless of whether the human detection unit outputs detection results.

In these image forming apparatuses of the related art, an intruder may take a printed paper sheet away if the functions of the image forming apparatuses are enabled in response to the detection of the intruder. The functions of the image forming apparatuses are typically disabled.

An authorized user may also use the functions of the image forming apparatus in a time band during which an intruder detection mode is active. If the functions of the image forming apparatus are uniformly disabled in such a case, the authorized user may have difficulty in retrieving a printed paper sheet. This inconveniences the user. However, if the image forming apparatus is enabled as usual, this leads to a security problem.

It is thus desirable to provide an image forming apparatus that is more user-friendly than those of the related art and that is free from the inconvenience that even an authorized user is unable to use the functions of the image forming apparatus if a human is detected.

### SUMMARY

According to an aspect of the disclosure, there is provided an image forming apparatus. The image forming apparatus includes an intruder detecting unit that detects an intruder, an intruder detection mode execution unit that executes an intruder detection mode by causing the intruder detecting unit to detect the intruder, a user authentication unit that performs user authentication, a job reception unit that receives an instruction to print print data, and a printing unit that prints the print data. If the job reception unit receives the instruction to print the print data while the intruder detection mode execution unit executes the intruder detection mode, the user authentication unit performs the user authentication, and the printing unit prints the print data after the user authentication unit has performed the user authentication of an authorized user.

### BRIEF DESCRIPTION OF THE DRAWINGS

FIG. 1 is an external perspective view of a digital multifunction apparatus as an image forming apparatus of an embodiment of the disclosure;

FIG. 2 is a plan view of the digital multifunction apparatus of FIG. 1;

FIG. 3 illustrates a panel unit of the digital multifunction apparatus of FIG. 1;

FIG. 4 is a block diagram generally illustrating the digital multifunction apparatus of FIG. 1;

FIG. 5 is a flowchart illustrating an intruder detection process of the digital multifunction apparatus of FIG. 1;

FIG. 6 is a flowchart illustrating the intruder detection process of the digital multifunction apparatus of FIG. 1;

FIG. 7 illustrates an example of a function restriction setting screen in the intruder detection mode of the digital multifunction apparatus of FIG. 1;

FIG. 8 illustrates an example of an activation and deactivation setting screen in the intruder detection mode of the digital multifunction apparatus of FIG. 1;

FIG. 9 illustrates an example of a schedule setting screen in the intruder detection mode of the image forming apparatus of FIG. 1;

FIG. 10 illustrates an example of a display screen in the intruder detection mode of the digital multifunction apparatus of FIG. 1;

FIG. 11 illustrates an example of a display screen of the digital multifunction apparatus when a human-body detecting sensor detects a heat source in the intruder detection mode of the digital multifunction apparatus of FIG. 1;

FIG. 12 illustrates as example of a display screen of the digital multifunction apparatus when the human-body detecting sensor detects a heat source in the intruder detection mode of the digital multifunction apparatus of FIG. 1;

FIG. 13 illustrates an example of a function restriction setting screen of the digital multifunction apparatus in the intruder detection mode;

FIG. 14, corresponding to FIG. 5, illustrates as intruder detection process of a digital multifunction apparatus of a third embodiment of the disclosure;

FIG. 15 is a flowchart illustrating the intruder detection process of the digital multifunction apparatus of the third embodiment of the disclosure;

FIG. 16 is a flowchart illustrating the intruder detection process of the digital multifunction apparatus of the third embodiment of the disclosure;

FIG. 17, corresponding to FIG. 5, illustrates the intruder detection process of the digital multifunction apparatus of a fourth embodiment of the disclosure;

FIG. 18, corresponding to FIG. 6, illustrates the intruder detection process of the digital multifunction apparatus of the fourth embodiment of the disclosure; and

FIG. 19 is a flowchart illustrating the intruder detection process of the digital multifunction apparatus of the fourth embodiment of the disclosure.

### DESCRIPTION OF THE EMBODIMENTS

Embodiments of the disclosure are described below in connection with the drawings. The embodiments of the disclosure are described for exemplary purposes only, and the description thereof is not intended to limit the disclosure

### First Embodiment

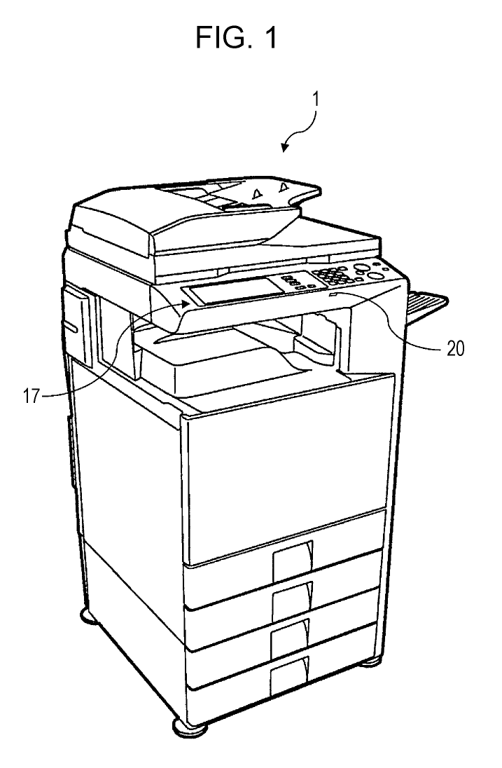

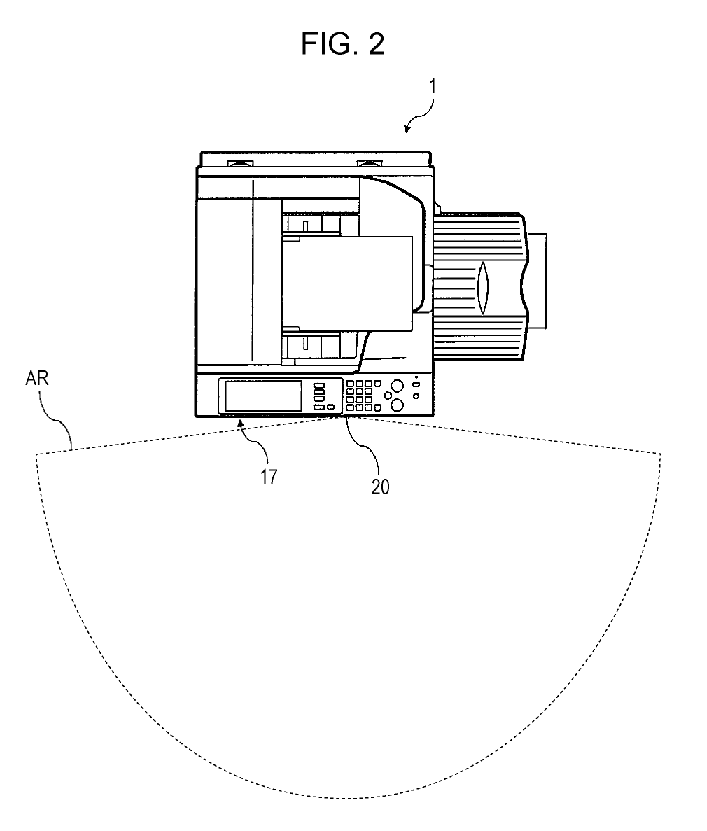

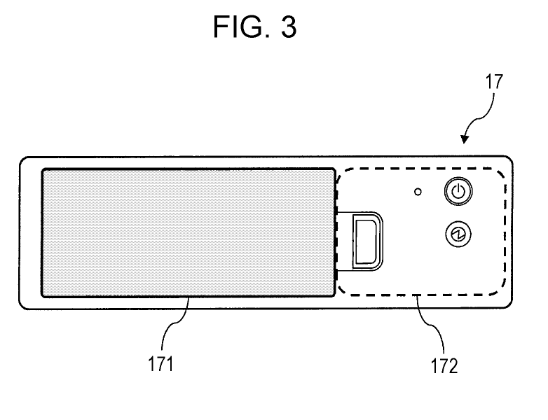

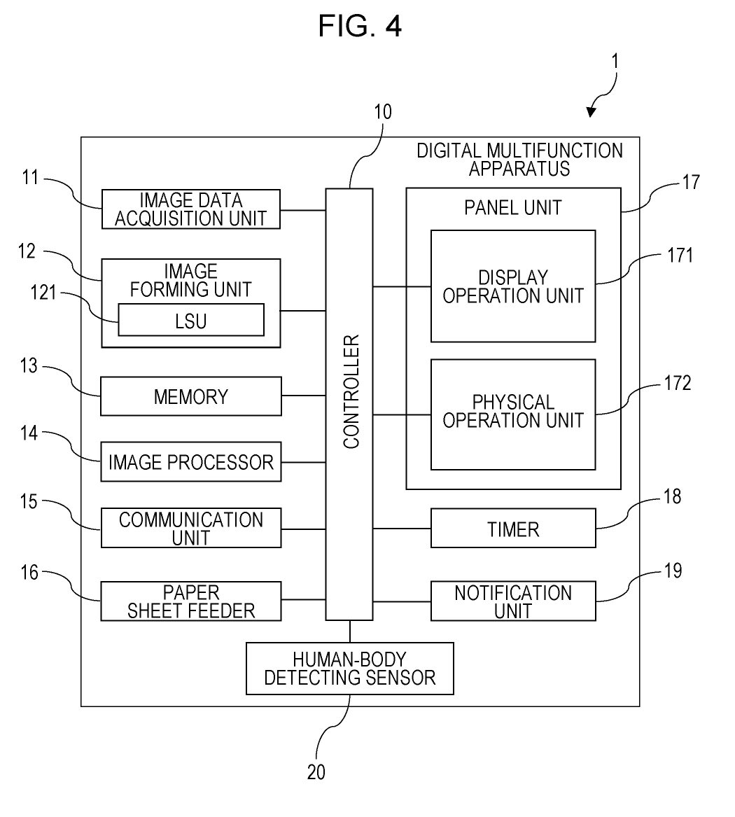

An digital multifunction apparatus 1 functioning as an image forming apparatus of a first embodiment of the disclosure is described below in connection with FIGS. 1 through 4. FIG. 1 is an external perspective view of the digital multifunction apparatus 1 functioning as the image forming apparatus of the first embodiment of the disclosure. FIG. 2 is a plan view of the digital multifunction apparatus 1 of FIG. 1. FIG. 3 illustrates a panel unit 17 in the image forming apparatus of FIG. 1. FIG. 4 is a block diagram generally illustrating the digital multifunction apparatus 1 of FIG. 1.

The digital multifunction apparatus 1 may be a multifunction apparatus or a multifunction peripheral (MFP) that digitally processes image data and has a copying function, a scanning function, and a facsimile function.

Referring to FIGS. 1 and 2, the digital multifunction apparatus 1 includes the panel unit 17, and a human-body detecting sensor 20 on the front portion of the panel unit 17. Referring to FIG. 3, the panel unit 17 includes a display operation unit 171 and a physical operation unit 172.

The configuration of the digital multifunction apparatus 1 is simply described first in connection with FIG. 4. Referring to FIG. 4, the digital multifunction apparatus 1 includes a controller 10, an image data acquisition unit 11, an image forming unit 12, a memory 13, an image processor 14, a communication unit 15, a paper sheet feeder 16, a panel unit 17, a timer 18, a notification unit 19, and a human-body detecting sensor 20. The elements of the digital multifunction apparatus 1 are described below.

The controller 10 generally controls the digital multifunction apparatus 1, and includes a central processing unit (CPU), a random-access memory (RAM), a read-only memory (ROM), and a variety of interface circuits. To generally control the digital multifunction apparatus 1, the controller 10 performs detection using sensors, and monitors and controls a variety of loads, including a motor, a clutch, and the panel unit 17.

The image data acquisition unit 11 detects and reads an original document placed on a document platen or an original document transported from an original document tray, and generates image data. Also, the image data acquisition unit 11 acquires image data generated in an external information processing apparatus (not illustrated) or a facsimile (fax) device (not illustrated). To acquire the image data from the external information processing apparatus or the like, the image data may be acquired via a wired or wireless network, or using a universal serial bus (USB) having the image data recorded thereon, or using a combination thereof.

The image forming unit 12 outputs the image data, acquired by the image data acquisition unit 11 and processed by the image processor 14, in a printed form on a paper sheet. The image forming unit 12 includes a laser scanning unit (LSU) 121. The LSU 121 irradiates the surface of a photoconductor drum in a charged state with a laser light beam corresponding to information in the image data, namely, a digital signal, and thus forms an electrostatic latent image.

The memory 13 is an element or a storage medium that stores a control program and information used to implement a variety of functions of the digital multifunction apparatus 1. The memory 13 may be a semiconductor device, such as a RAM or a ROM, or a memory medium, such as a hard disk, a flash memory, or a solid state semiconductor drive (SSD). The program and data may be stored on separate devices, for example, a region storing data may be the hard disk drive, and a region storing the program may be a flash memory.

The image processor 14 converts an original document image read by the image data acquisition unit 11 into an appropriate electrical signal, thereby generating the image data. The image processor 14 thus processes the image data input from the image data acquisition unit 11 to output an expanded image or contacted image in response to an instruction from the display operation unit 171.

The communication unit 15 communicates with an external image forming apparatus 2, a computer, a mobile information terminal, an information processing apparatus, a facsimile device, and the like via the network 3. The communication unit 15 thus transmits or receives a variety of information including mails and facsimile (FAX) data to or from the external device, such as the external image forming apparatus 2.

The paper sheet feeder 16 transports a paper sheet placed in a paper feeder cassette or a manual feeding tray to the image forming unit 12.

The panel unit 17 includes a liquid-crystal display (LCD), and includes the display operation unit 171 and the physical operation unit 172.

The display operation unit 171 displays a variety of information. The display operation unit 171 includes a cathode ray tube (CRT) display, an LCD display, or an electroluminescent (EL) display, for example. The display operation unit 171 is a display device, such as a monitor or a line-display, which displays electronic data related to the process state of an operating system and a software application. The controller 10 displays the operation and state of the digital multifunction apparatus 1 via the display operation unit 171.

The display operation unit 171 includes a touch panel, and receives an instruction from a user.

The timer 18 measures and counts time. For example, the timer 18 acquires time from an internal clock or via the network 3.

The notification unit 19 causes an audio sound generator, such as a speaker, to generate a sound, such as a buzzer sound or a message. The notification unit 19 thus notifies nearby users of the warning or the message. The notification unit 19 may also transmit an alert mail to an external server via the network 3 or may contact a security firm. An administrator may register in advance a mail address serving as a destination of the alert mail and a contact address of the security firm.

The human-body detecting sensor 20 detects an intruder within a predetermined area. The human-body detecting sensor 20 may be a pyroelectric infrared sensor including a pyroelectric element that detects a change in infrared light created by the motion of an intruder. An intruder may also be detected by analyzing the image acquired by the imaging device, such as a camera. In such a case, a picture of a predetermined area is taken at predetermined time intervals, and the presence or absence of a change is detected between the images of multiple frames taken. If a change is noticed between images, intruder detection is performed based on the assumption that the intruder is found.

Referring to FIG. 2, a sector area AR represents an area where the human-body detecting sensor 20 detects an intruder. If a user enters the area AR, the human-body detecting sensor 20 detects the user. The human-body detecting sensor 20 provides an output if a target is present within the predetermined area (for example, a sector having a radius of 0 to 5 meters), and the output level varies depending on the distance to the target.

The configuration of digital multifunction apparatus 1 has been described above.

### Intruder Detection Process of the First Embodiment of the Disclosure

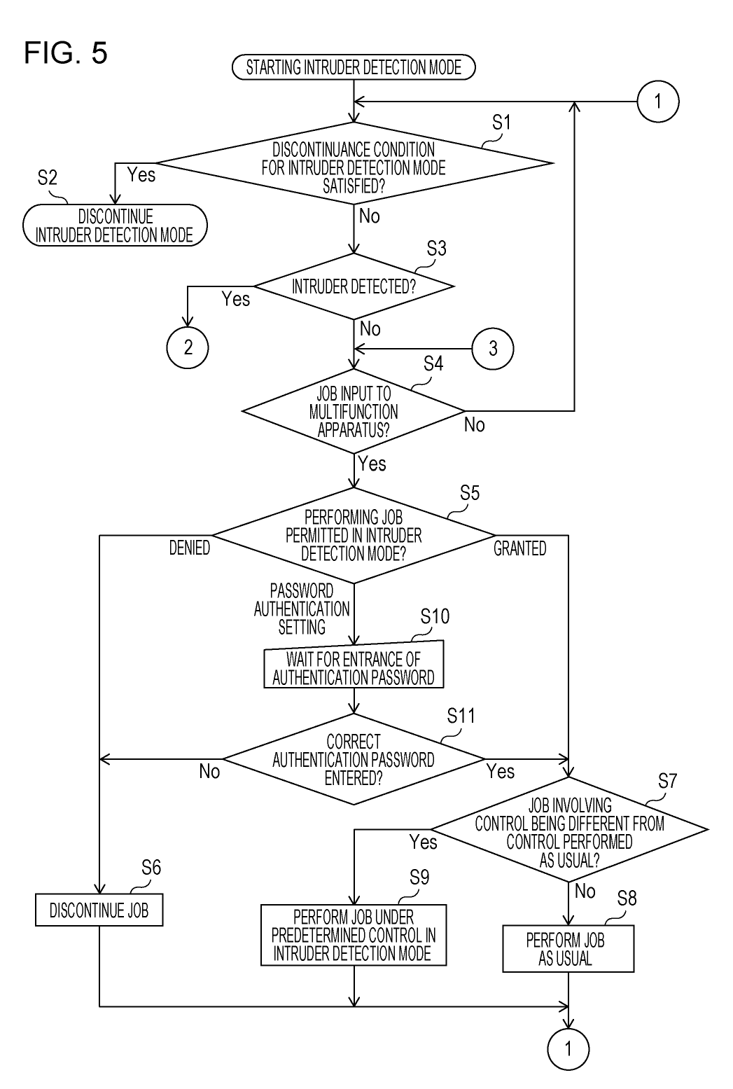

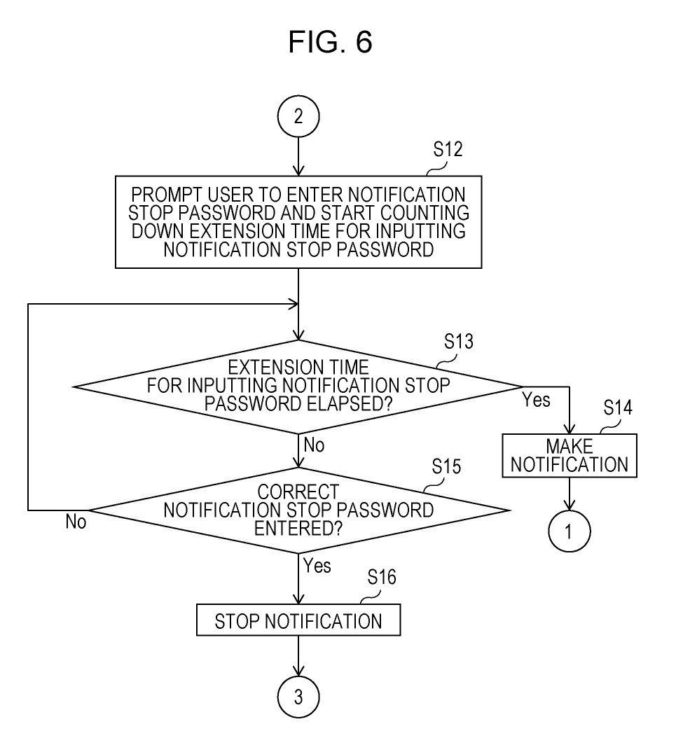

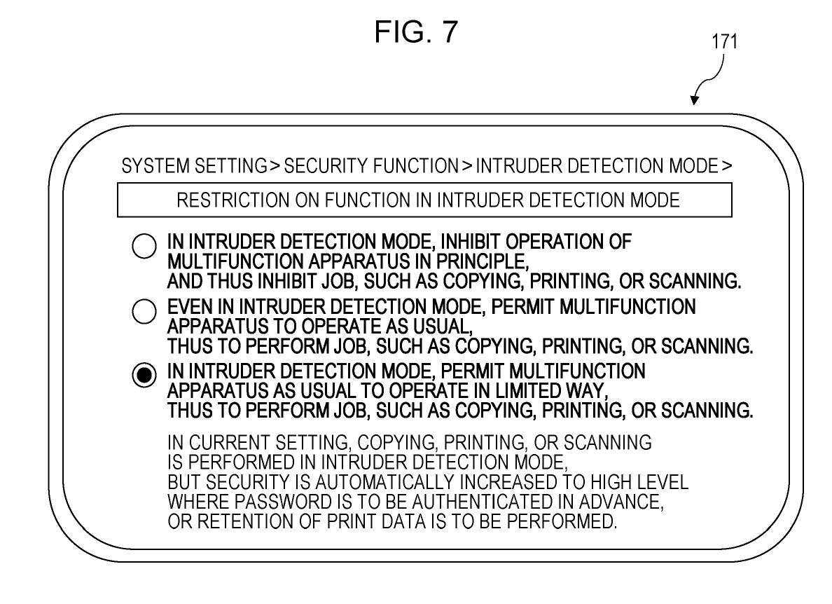

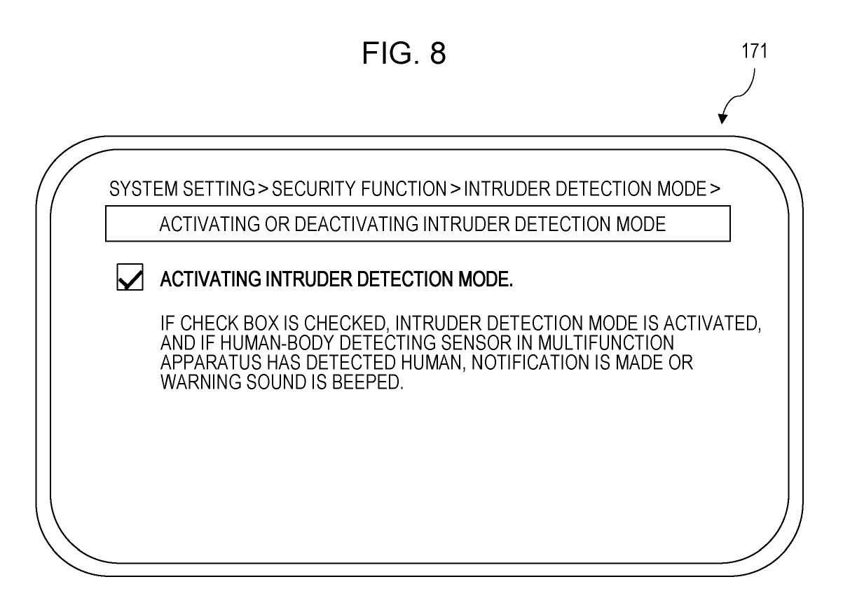

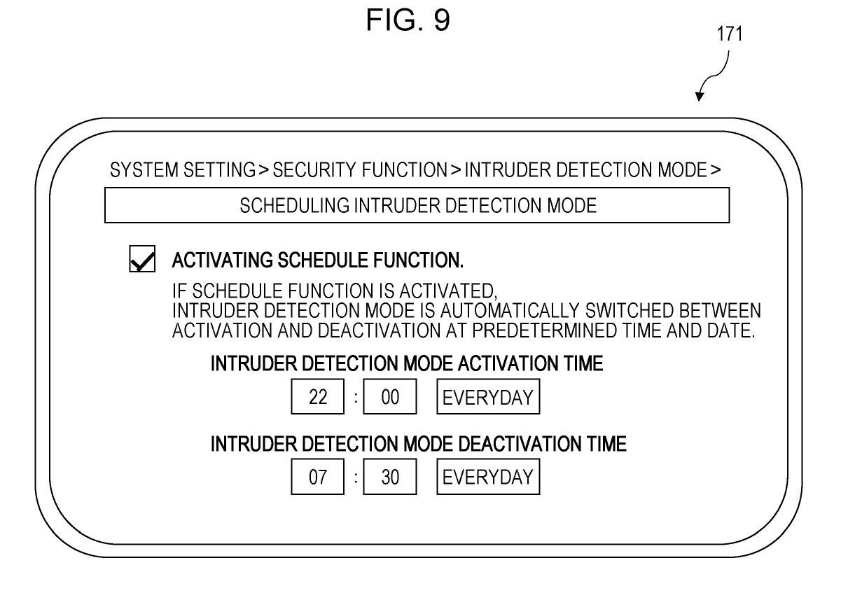

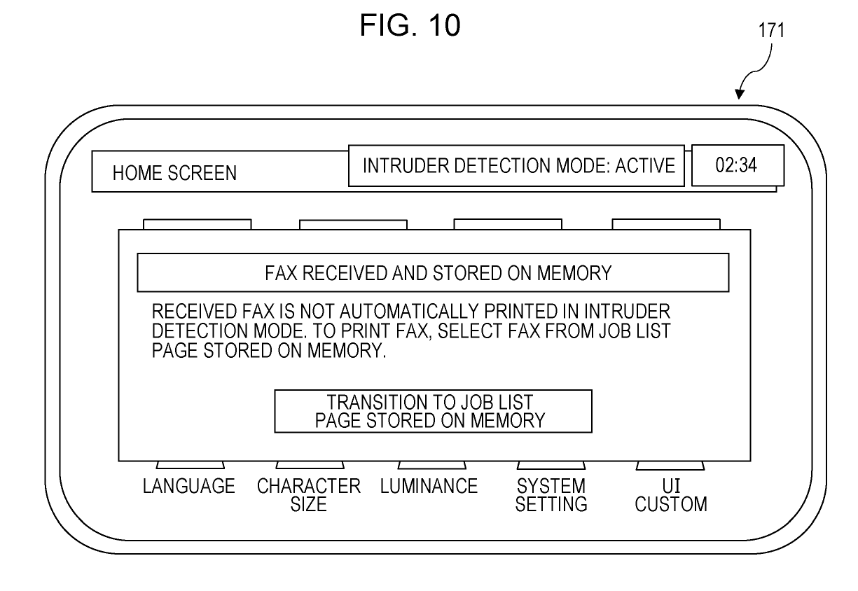

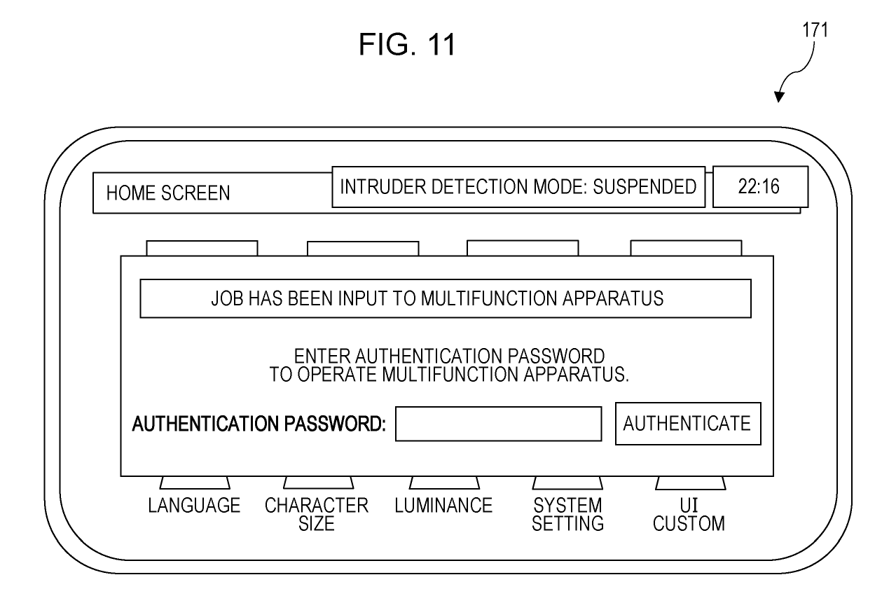

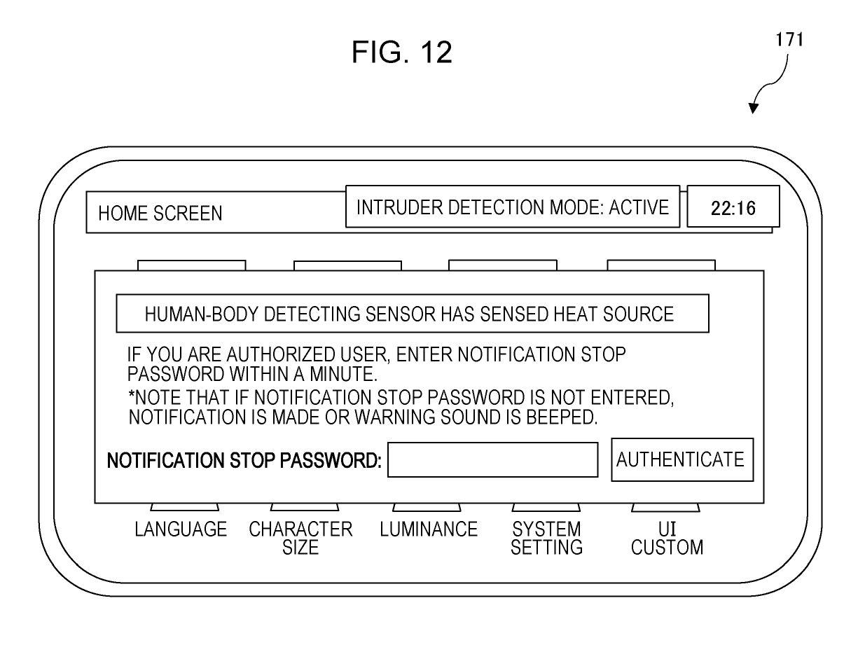

An intruder detection process of the first embodiment of the disclosure is described in connection with FIGS. 5 through 12. FIGS. 5 and 6 are flowcharts illustrating the intruder detection process of the digital multifunction apparatus 1 of FIG. 1. FIG. 7 illustrates an example of a function restriction setting screen in the intruder detection mode of the digital multifunction apparatus 1 of FIG. 1. FIG. 8 illustrates an example of an activation and deactivation setting screen in the intruder detection mode of the digital multifunction apparatus 1 of FIG. 1. FIG. 9 illustrates an example of a schedule setting screen in the intruder detection mode of the digital multifunction apparatus 1 of FIG. 1. FIG. 10 illustrates an example of a display screen in the intruder detection mode of the digital multifunction apparatus 1 of FIG. 1. FIGS. 11 and 12 illustrate examples of a display screen when a human-body detecting sensor 20 detects a heat source in the intruder detection mode of the digital multifunction apparatus 1 of FIG. 1.

In step S1 of FIG. 5, the controller 10 determines whether a predetermined discontinuance condition for the intruder detection mode is satisfied (step S1). For example, the discontinuance condition of the intruder detection mode may be a predetermined deactivation time of the intruder detection mode.

If the discontinuance condition of the intruder detection mode is satisfied (yes branch from step S1), the controller 10 discontinues the intruder detection mode in step S2 (step S2).

If the discontinuance condition of the intruder detection mode is not satisfied (no branch from step S1), the controller 10 determines in step S3 whether the human-body detecting sensor 20 has detected an intruder (step S3).

If the human-body detecting sensor 20 has detected an intruder (yes branch from step S3), the controller 10 performs an operation in step S12 of FIG. 6 (step S12 of FIG. 6).

If the human-body detecting sensor 20 has not detected an intruder (no branch from step S3), the controller 10 determines in step S4 whether a job has been input to the digital multifunction apparatus 1 (step S4).

If a job has not been input to the digital multifunction apparatus 1 (no branch from step S4), the controller 10 repeats the determination operation in step S1 (step S1).

If a job has been input to the digital multifunction apparatus 1 (yes branch from step S4), the controller 10 checks the setting of permission to perform the job in the intruder detection mode in step S5 (step S5).

Referring to FIG. 7, a user serving as an administrator sets function restriction in the intruder detection mode of the digital multifunction apparatus 1 in advance.

If the radio button for the message reading “In intruder detection mode, inhibit operation of multifunction apparatus in principle, and thus inhibit job, such as copying, printing, or scanning” is selected, the functions of the digital multifunction apparatus 1 in the intruder detection mode are fully restricted.

On the other hand, if the radio button for the message reading “Even in intruder detection mode, permit multifunction apparatus to operate as usual, thus to perform job, such as copying, printing, or scanning” is selected, the functions of the digital multifunction apparatus 1 are fully permitted in the intruder detection mode.

There have been two permit options in the related art: the functions of the digital multifunction apparatus 1 in the intruder detection mode are fully restricted or fully permitted.

According to the disclosure, if the radio button for the message reading “In intruder detection mode, permit multifunction apparatus to operate in limited way, thus to perform job, such as copying, printing, and scanning” is selected, the functions of the digital multifunction apparatus 1 in the intruder detection mode are permitted in a limited way.

Referring to FIG. 7, the display operation unit 171 may display the selected option. In the example of FIG. 7, the display operation unit 171 displays the message reading “In current setting, copying, printing, or scanning is performed in intruder detection mode, but security is automatically increased to high level where password is to be authenticated in advance, or retention of print data is to be performed”.

Referring to FIG. 8, the user serving as the administrator may set the intruder detection mode of the digital multifunction apparatus 1 to be activated or deactivated. If the check box for the message reading “Activating intruder detection mode” is checked, the intruder detection mode is activated.

Referring to FIG. 8, the display operation unit 171 may display the explaining message reading “If check box is checked, intruder detection mode is activated, and if human-body detecting sensor in multifunction apparatus has detected human, notification is made or warning sound is beeped”.

Referring to FIG. 9, the user serving as the administrator may set the schedule of the intruder detection mode of the digital multifunction apparatus 1. If the check box for the message reading “Activating schedule function” is checked, the schedule function of the intruder detection mode is activated.

Referring to FIG. 9, intruder detection mode activation time is set to “22:00 everyday”, and intruder detection mode deactivation time is set to be “07:30 everyday”.

Referring to FIG. 9, the display operation unit 171 may display the explaining message reading “If schedule function is activated, intruder detection mode is automatically switched between activation and deactivation at predetermined time and date”.

If performing the job in the intruder detection mode is not permitted in step S5 of FIG. 5 (performing the job is denied in the determination in step S5), the controller 10 discontinues the job in step S6 (step S6). The controller 10 then repeats the determination operation in step S1 (step S1).

On the other hand, if performing the job in the intruder detection mode is permitted (performing the job is granted in the determination in step S5), the controller 10 determines whether the job involves control different from control in normal operation (step S7).

If the job involves the control different from the control in the normal operation (yes branch from step S7), the controller 10 performs the job under predetermined control in the intruder detection mode (step S9). The controller 10 then repeats the determination operation in step S1 (step S1).

FIG. 10 illustrates an example of a display screen of the display operation unit 171 when a fax is received with the intruder detection mode activated.

When the communication unit 15 receives a fax in the intruder detection mode, the controller 10 stores fax data on the memory 13 instead of printing the fax.

Referring to FIG. 10, the display operation unit 171 displays the message reading “Fax received and stored on memory”. The display operation unit 171 displays the icon indicating “Transition to job list page stored on memory” together with the explaining message reading “Received fax is not automatically printed in intruder detection mode. To print fax, select fax from job list page stored on memory”.

The user may select a desired job from a job list page stored on the memory by clicking on the icon indicating “Transition to job list page stored on memory”.

If the job does not involve the control different from the control in the normal operation (no branch from step S7) as illustrated in FIG. 5, the controller 10 performs the job as usual in step S8 (step S8). The controller 10 then repeats the determination operation in step S1 (step S1).

If the password authentication setting is effective in step S5, the controller 10 waits for the input of the authentication password in step S10 (step S10).

Referring to FIG. 11, the display operation unit 71 displays the message “Job has been input to multifunction apparatus”. The display operation unit 171 displays an input box of the authentication password and an authentication icon together with the explaining message reading “Enter password to operate multifunction apparatus”. The display operation unit 171 thus prompts the user to enter the authentication password.

When the authentication password is entered, the controller 10 determines in step S11 whether the correct authentication password has been entered (step S11). If the correct authentication password has been entered (yes branch from step S11), the controller 10 performs the determination operation in step S7 (step S7). On the other hand, if the correct authentication password has not been entered (no branch from step S11), the controller 10 performs the operation in step S6 (step S6).

In step S12 of FIG. 6, the controller 10 causes the display operation unit 171 to display an indication that prompts the user to enter a notification stop password. The controller 10 also causes the timer 18 to count down the extension time for the input of the notification step password (step S12).

Referring to FIG. 12, the display operation unit 171 displays the message reading “Human-body detecting sensor has sensed heat source”. The display operation unit 171 also displays the input box of the authentication password and the authentication icon together with the explaining message reading “If you are authorized user, enter notification stop password within a minute. Note that if notification stop password is not entered, notification is made or warning sound is beeped”. The display operation unit 171 thus prompts the user to enter the notification stop password.

In step S13, the controller 10 determines whether the extension time for inputting the notification stop password has elapsed (step S13). If the extension time for inputting the notification stop password has elapsed (yes branch from step S13), the controller 10 causes the notification unit 19 to make a notification in step S14 (step S14). The controller 10 then repeats the determination operation in step S1 (step S1).

If the extension time for inputting the notification stop password has not elapsed (no branch from step S13), the controller 10 determines in step S15 whether the correct authentication password has been entered on the display operation unit 171 (step S15).

If the correct authentication password has been entered on the display operation unit 171 (yes branch from step S15), the controller 10 causes the notification unit 19 to discontinue the notification (step S16). On the other hand, if the correct authentication password has not been entered on the display operation unit 171 (no branch from step S15), the controller 10 repeats the determination operation in step S13 (step S13).

Referring to FIG. 12, the authorized user may discontinue the notification by pressing the authorization icon after entering the notification stop password in the input box displayed on the display operation unit 171 in the extension time.

The job may be performed by performing the predetermined operation even in the intruder detection mode. The authorized user is thus free from the inconvenience that he or she is unable to use the functions of the image forming apparatus 1. The digital multifunction apparatus 1 more user-friendly than digital multifunction apparatuses of the related art thus results.

### Second Embodiment

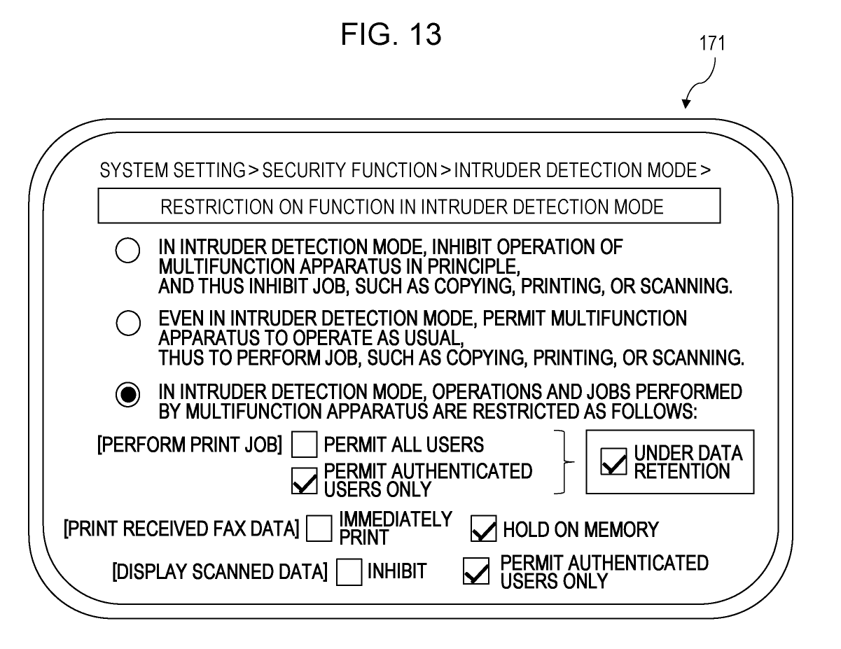

The function restriction setting in the intruder detection mode of a second embodiment of the disclosure is described in connection with FIG. 13. FIG. 13 illustrates an example of a function restriction setting screen in the intruder detection mode of the digital multifunction apparatus 1.

According to the first embodiment, the functions of the digital multifunction apparatus 1 in the intruder detection mode are permitted in a limited way if the radio button for the message reading “In intruder detection mode, permit multifunction apparatus to operate in limited way, thus to perform job, such as copying, printing, and scanning” is selected.

According to the second embodiment, a fine function restriction setting is made by selecting the radio button for the message reading “In intruder detection mode, operations and jobs performed by multifunction apparatus are restricted as follows:” as illustrated in FIG. 13.

In the example of FIG. 13, the act of performing the job (“Perform print job”) may be selectively switched between “Permit all users” and “Permit authenticated users only”.

If the check box for “Under data retention” is checked, the retention function that the print job received in the intruder detection mode is not immediately performed but temporarily stored on the memory is activated.

If the check box for “Immediately print” is checked in the line reading “Print received fax data”, fax data received in the intruder detection mode is immediately printed. On the other hand, the check mark for “Hold on memory” is checked, a memory hold function is activated to store the fax data received in the intruder detection mode on the memory.

The data stored on the memory is held until the user performs a manual print operation. Alternatively, however, the data may be automatically printed at the end time of the intruder detection mode.

If the check box for “Inhibit” is checked in the line reading “Display scanned data”, scanned data is no longer displayed. If the check box for “Permit authorized users only” is checked, the scanned data is displayed to the authorized users only.

The fine function restriction is set in the intruder detection mode in this way. The authorized user is thus free from the inconvenience that he or she is unable to use the functions of the image forming apparatus 1. The digital multifunction apparatus 1 more user-friendly than digital multifunction apparatuses of the related art thus results.

### Third Embodiment

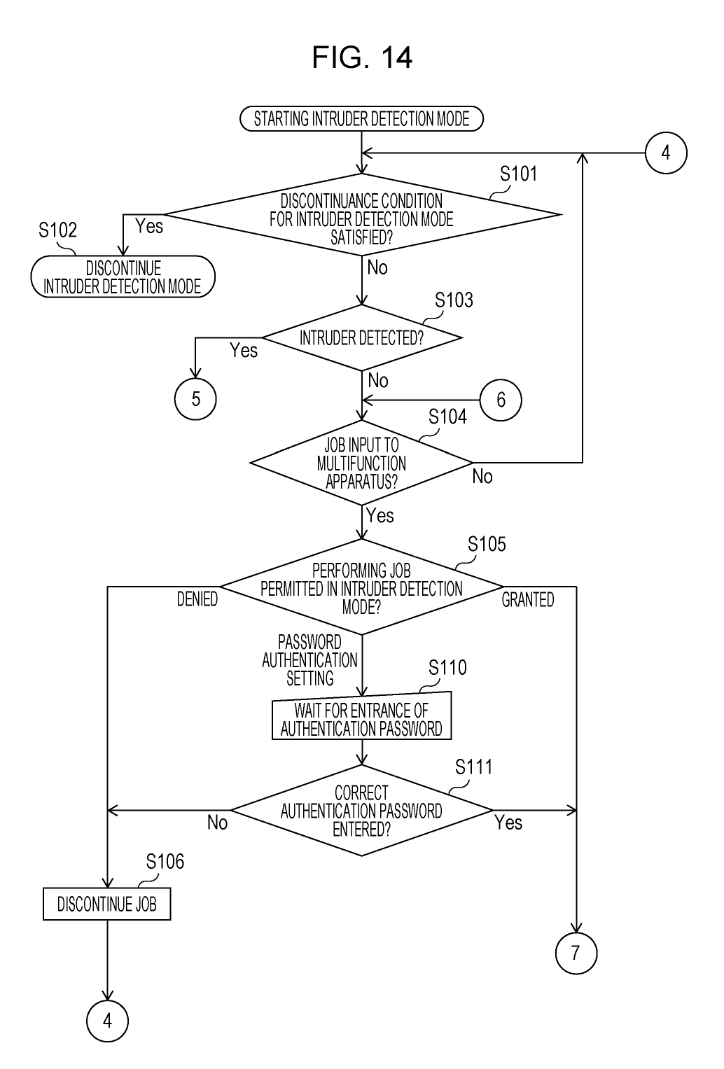

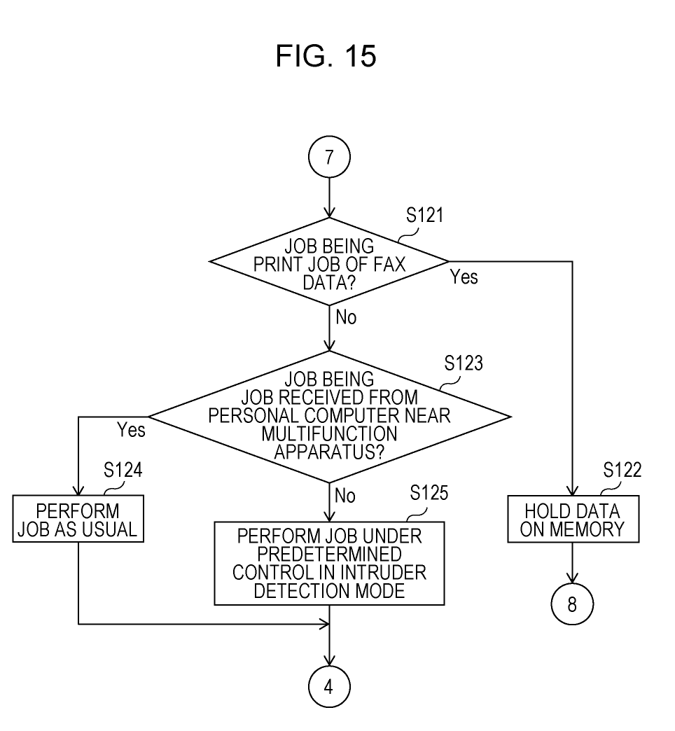

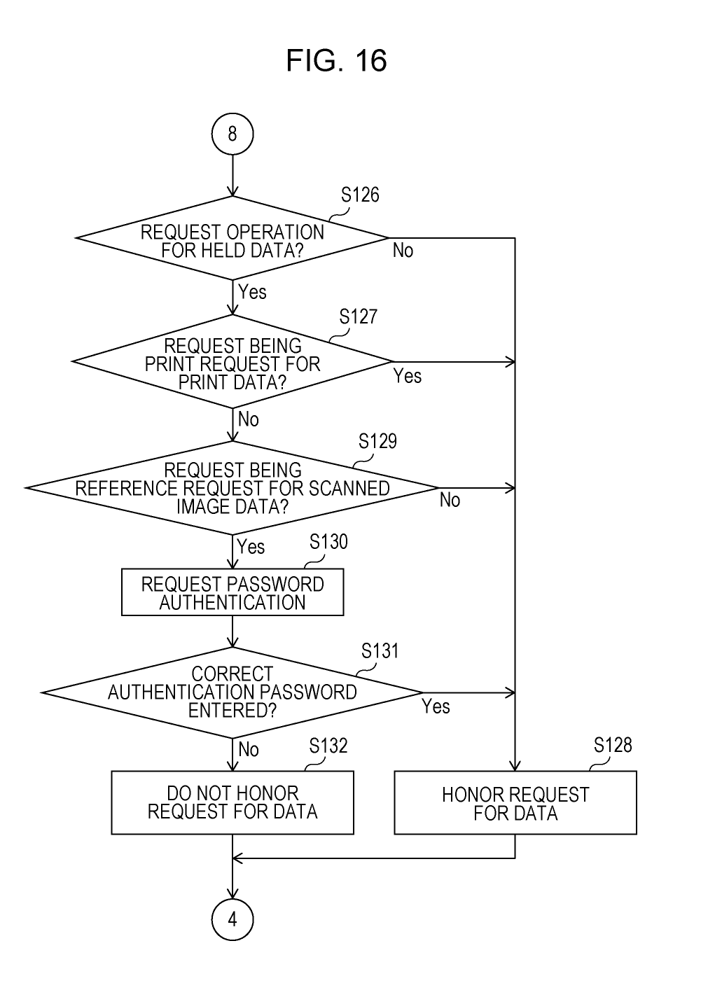

The intruder detection process of a digital multifunction apparatus 1 of a third embodiment of the disclosure is described in connection with FIGS. 14 through 16. FIG. 14, corresponding to FIG. 5, illustrates the intruder detection process of the digital multifunction apparatus 1 of the third embodiment of the disclosure. FIGS. 15 and 16 are flowcharts illustrating the intruder detection process of the digital multifunction apparatus 1 of the third embodiment of the disclosure.

Steps S101 through S106 and steps S110 and S111 of FIG. 14 respectively correspond to steps S1 through S6, and S10 and S11 of FIG. 5, and the detailed discussion thereof is omitted herein.

According to the third embodiment as illustrated in FIG. 14, if performing the job is enabled in step S105 or S111 (step S105 or S111), the controller 10 performs an operation different depending on the type of the job as illustrated in FIG. 15.

Specifically, the controller 10 determines in step S121 of FIG. 15 whether the job is the print job of the fax data (step S121). If the job is the print job of the fax data (yes branch from step S121), the controller 10 holds the fax data on the memory instead of printing the print data in step S122 (step S122).

If the fax data is printed, the printed paper sheet may not immediately be retrieved by the user, and the fax data is held on the memory. The controller 10 then performs a determination operation in step S126 of FIG. 16 (step S126).

If the job is not the print job of the fax data (no branch from step S121), the controller 10 determines in step S123 whether the job is received from a personal computer (PC) or the like located within a predetermined range (for example, within a range of several tens of meters) from the digital multifunction apparatus 1 (step S123).

If the job is received from the PC or the like located within the predetermined range from the digital multifunction apparatus 1 (yes branch from step S123), the controller 10 performs the job as usual in step S124 (step S124).

If the job is received from the PC or the like located within the predetermined range from the digital multifunction apparatus 1 in this way, the user is likely to retrieve a printed paper sheet. The print data is thus immediately printed instead of being stored on the memory.

If the job is not received from the PC or the like located within the predetermined range from the digital multifunction apparatus 1 (no branch from step S123), the controller 10 performs the job under predetermined control in the intruder detection mode in step S125 (step S125). The controller 10 then repeats the determination operation in step S101 (step S101).

In step S126 of FIG. 16, the controller 10 determines whether a request operation for held data has been made via the display operation unit 171 by the user (step S126).

The request operation for held data may be a print request to print print data or a reference request to reference scanned image data.

If the request operation for the held data has been made (yes branch from step S126), the controller 10 determines in step S127 whether the request is the print request to print the print data (step S127). On the other hand, if the request operation for the held data has not been made (no branch from step S126), the controller 10 honors the request for the held data in step S128 (step S128).

In step S127, the controller 10 determines whether the request is the print request of the print data (step S127). If the print data is the print request of the print data (yes branch from step S127), the controller 10 honors the print request, thereby performing the print operation in step S128 (step S128). If the request is not the print request of the print data (no branch from step S127), the controller 10 determines whether the request is the reference request of the scanned image data (step S129).

If the request is the reference request of the scanned image data (yes branch from step S129), the controller 10 requests password authentication in step S130 (step S130). The controller 10 then performs a determination operation in step S131 (step S131).

If the request is not the reference request of the scanned image data (no branch from step S129), the controller 10 performs the operation in step S128 (step S128).

In step S131, the controller 10 determines whether the correct authentication password has been entered (step S131). If the correct authentication password has been entered (yes branch from step S131), the controller 10 honors the reference request of the scanned image data (step S128). If the correct authentication password has not been entered (no branch from step S131), the controller 10 does not honor the reference request of the scanned image data (step S132), but repeats the determination operation in step S101 (step S101).

In this way in the intruder detection mode, the password authentication may not be requested in the printing of the print data but the password authentication may be requested in the reference of the scanned image data stores on the memory in the digital multifunction apparatus 1.

A different operation is performed in the intruder detection mode depending on the type of the job. The digital multifunction apparatus 1 more user-friendly than digital multifunction apparatuses of the related art thus results.

### Fourth Embodiment

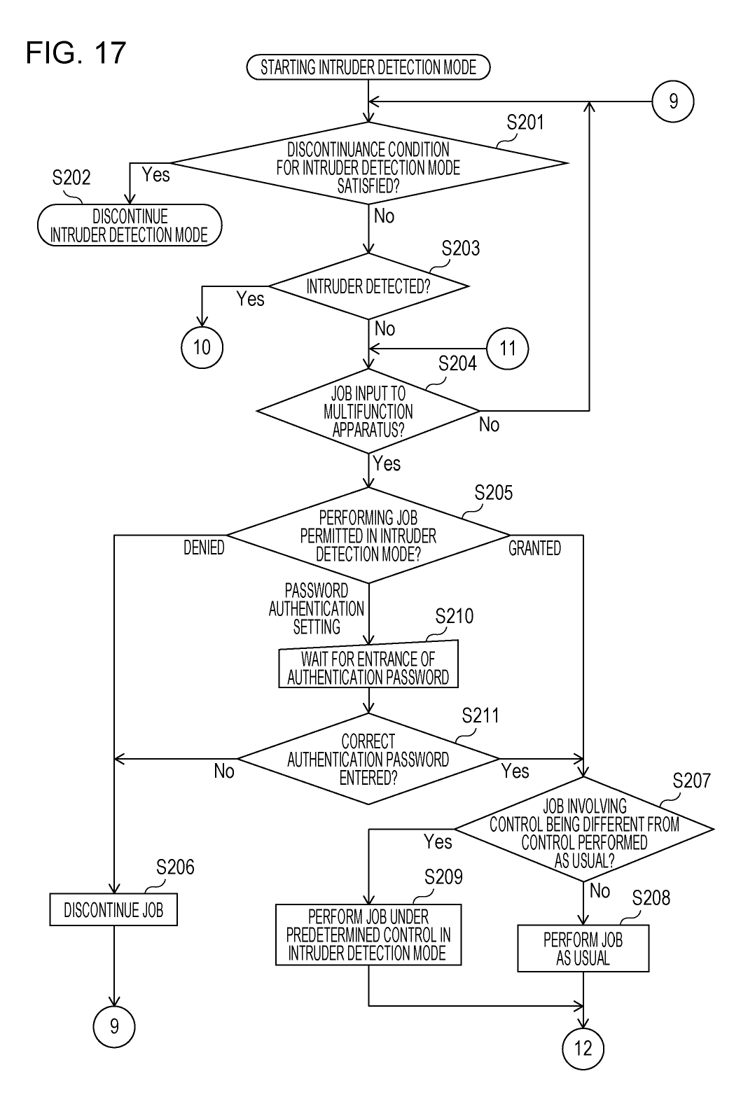

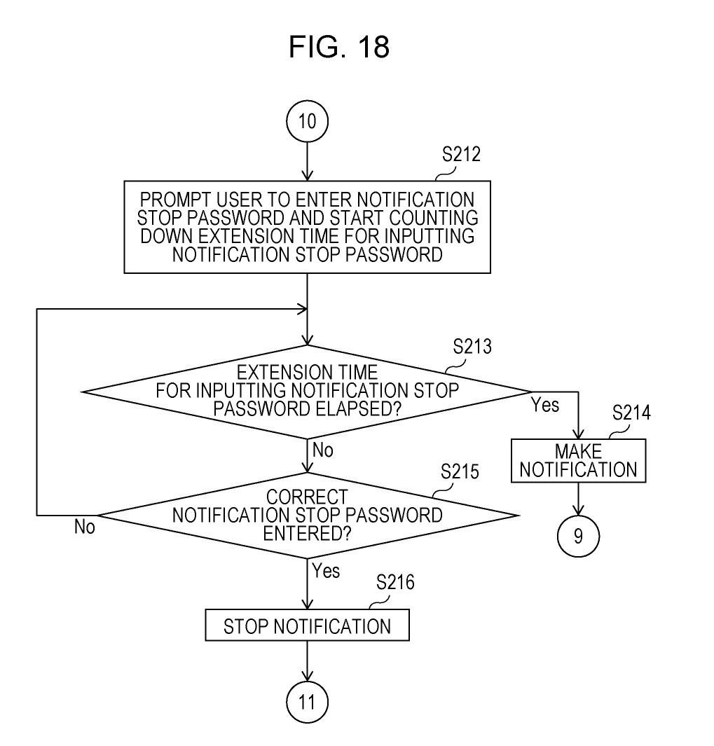

The intruder detection process of a digital multifunction apparatus 1 of a fourth embodiment of the disclosure is described in connection with FIGS. 17 through 19. FIG. 17, corresponding to FIG. 5, illustrates the intruder detection process of a digital multifunction apparatus 1 of the fourth embodiment of the disclosure. FIG. 18, corresponding to FIG. 6, illustrates the intruder detection process of the digital multifunction apparatus 1 of the fourth embodiment of the disclosure. Also, FIG. 18 is a flowchart illustrating the intruder detection process of the digital multifunction apparatus 1 of the fourth embodiment of the disclosure.

Steps S201 through S211 of FIG. 17 respectively correspond to steps S1 through S11 of FIG. 5, steps S212 through S216 of FIG. 18 respectively correspond to steps S12 through S16 of FIG. 6, and the detailed discussion thereof is omitted herein.

According to the first embodiment, the authorized user may come to see the operation status of the digital multifunction apparatus 1 that is printing a large amount of data, and may be detected. The display operation unit 171 may display an indication that prompts the authorized user to enter the notification stop password, but the authorized user may not notice the indication.

According to the fourth embodiment, if an intruder is detected while the job involving printing is being performed, a notification may not be made but suspended during the printing, a request to enter the notification step password may be made subsequent to the completion of the printing, and the notification stop password may be acceptable until the elapse of a fixed period of time subsequent to the completion of the printing.

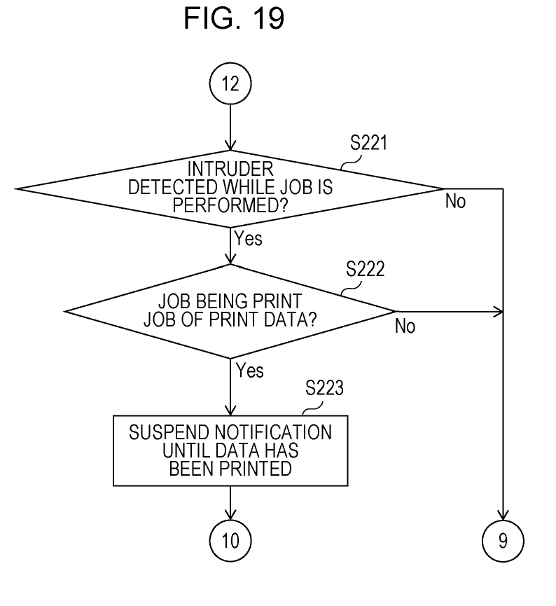

Specifically, after performing the job in step S208 or S209 (step S208 or S209) as illustrated in FIG. 17, the controller 10 then determines in step S221 of FIG. 19 whether the human-body detecting sensor 20 has detected an intruder while the job is performed (step S221).

If the human-body detecting sensor 20 has detected an intruder (yes branch from step S221) while the job is being made, the controller 10 determines in step S222 whether the job is the print job of the print data (step S222). On the other hand, if the human-body detecting sensor 20 has not detected an intruder (no branch from step S221) while the job is being made, the controller 10 repeats the determination operation in step S201 (step S201).

If it is determined in step S222 that the job is the print job of the print data (yes branch from step S222), the controller 10 causes in step S223 the notification unit 19 to suspend the notification until the completion of the printing of the print data (step S223). The controller 10 then repeats the operation in step S212 (step S212).

If it is determined in step S222 that the job is not the print job of the print data (no branch from step S222), the controller 10 then repeats the operation in step S201 (step S201).

In this way, the authorized user who comes to see the operation status of the digital multifunction apparatus 1 that is printing a large amount of data is less likely to fail to notice the indication that prompts the authorized user to enter the notification stop password. The digital multifunction apparatus 1 more user-friendly than digital multifunction apparatuses of the related art results.

The present disclosure contains subject matter related to that disclosed in Japanese Priority Patent Application JP 2018-043007 filed in the Japan Patent Office on Mar. 9, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image forming apparatus comprising:
an intruder detecting unit that detects an intruder;
an intruder detection mode execution unit that executes an intruder detection mode by causing the intruder detecting unit to detect the intruder;
a user authentication unit that performs user authentication;
a job reception unit that receives an instruction to print print data; and
a printing unit that prints the print data,
wherein if the job reception unit receives the instruction to print the print data while the intruder detection mode execution unit executes the intruder detection mode, the user authentication unit performs the user authentication, and the printing unit prints the print data after the user authentication unit has performed the user authentication of an authorized user.

2. The image forming apparatus according to claim 1, wherein the printing unit prints the print data if a predetermined password is entered within a predetermined extension time after the user authentication unit begins the user authentication.

3. The image forming apparatus according to claim 2, further comprising a notification unit that notifies detection of the intruder,
wherein if the predetermined password is not entered within the predetermined extension time, the job reception unit discontinues reception of the instruction to print the print data, and the notification unit does not notifies the detection of the intruder even if the intruder is detected.

4. The image forming apparatus according to claim 1, further comprising a notification unit that notifies detection of the intruder,
wherein if the intruder detecting unit detects the intruder during execution of the intruder detection mode, the user authentication unit performs the user authentication, and if a predetermined password is entered within a predetermined extension time after the user authentication unit begins the user authentication, the notification unit does not notify the detection of the intruder even if the intruder is detected.

5. The image forming apparatus according to claim 4, wherein the notification unit notifies the detection of the intruder if the predetermined password is not entered within the predetermined extension time.

6. The image forming apparatus according to claim 1, further comprising:
a memory that stores data; and
an operation unit that receives an instruction from a user,
wherein if the job reception unit receives the instruction to print the print data related to a predetermined confidential job while the intruder detection mode execution unit executes the intruder detection mode, the memory stores the print data, and if the operation unit receives the instruction to cause the printing unit to print the print data after the intruder detection mode execution unit discontinues the intruder detection mode to detect the intruder, the printing unit prints the print data.

7. The image forming apparatus according to claim 6, further comprising a communication unit that communicates with an external device,
wherein the predetermined confidential job includes a job related to printing of print data that the communication unit has received from the external device.
